(19) United States
(12) Patent Application Publication
(10) Pub. No.: US 2016/0288085 A1
(43) Pub. Date: Oct. 6, 2016

(54) DOLOMITE-BASED MATERIAL HAVING HIGH SPECIFIC SURFACE AREA, A METHOD FOR PREPARING THEREOF, A METHOD FOR CONTROLLING A QUALITY THEREOF, AND A METHOD FOR ADSORBING HEAVY METAL, HALOGEN AND METALLOID

(71) Applicant: Sumitomo Osaka Cement Co., Ltd., Tokyo (JP)

(72) Inventors: YUUKI ITAYA, Tokyo (JP); KENJI KUNINISHI, Tokyo (JP); SHINTARO HAYASHI, Tokyo (JP)

(21) Appl. No.: 15/084,606

(22) Filed: Mar. 30, 2016

(30) Foreign Application Priority Data
Mar. 31, 2015 (JP) 2015-074265

(51) Int. Cl. B01J 20/04; B01J 20/30; B09C 1/08; B01J 20/02

(52) U.S. Cl. CPC B01J 20/043; B01J 20/0229; B01J 20/3078; B09C 1/08

(57) ABSTRACT

A dolomite-based material having a high specific surface area of the present invention is half-fired dolomite in which a content of a residual CaMg(CO₃)₂ phase in the half-fired dolomite, which is analyzed using a Rietveld method by means of powder X-ray diffraction, is 0.4δ×δ35.4 (wt %), and, when the content of the residual CaMg(CO₃)₂ phase in the fired-dolomite is maintained at 0.4δ×δ35.4 (wt %), the dolomite-based material maintains quality of having a high specific surface area.

### CROSS-REFERENCE TO RELATED APPLICATIONS

This application claims the benefit of Japanese Patent Application No. 2015-074265 filed Mar. 31, 2015, the disclosure of which is herein incorporated by reference in its entirety.

### BACKGROUND OF THE INVENTION

1. Field of the Invention

The present invention relates to a dolomite-based material having a high specific surface area, a method for preparing thereof, and a method for controlling a quality thereof, and a method for adsorbing heavy metal, halogen and metalloid, and particularly to a dolomite-based material which shows an enhanced adsorption ability of heavy metal, halogen and metalloid due to having the high specific surface area, a method for preparing thereof, a method for controlling a quality thereof, and a method for adsorbing heavy metal, halogen and metalloid.

2. Related Art

As an agent used as an insolubilization material of heavy metal, halogen and metalloid in a drainage treatment and in soils, sodium sulfate, ferric chloride, ferrous sulfate, magnesium oxide, a titanium salt, a cerium salt, a chelating agent, hydrotalcite, schwertmannite, and the like are known, but these agents have problems of a low insolubilization effect, a low coping ability with combined contamination, a high cost, unstable procurement, and the like.

In consideration of the above problems, as an insolubilization material, a dolomite-based adsorbent of half-fired dolomite, calcined dolomite, partially decomposed dolomite, or the like is proposed, and, for example, the following dolomite materials are disclosed.

Japanese Laid-open Patent Publication No. 2012-157834A (Patent Document 1) discloses a remover of fluorine and/or heavy metal ions in waste water which is obtained by firing dolomite and is made of a blend of half-fired dolomite having a content of free calcium oxide of 1.2% by weight or lower and a content of free magnesium oxide of 8% by weight or higher and a water-soluble iron compound.

In addition, Japanese Laid-open Patent Publication No. 2011-240325A (Patent Document 2) discloses a remover of heavy metal ions and(/or) phosphoric acid ions in waste water which is obtained by firing dolomite and includes as an effective component half-fired dolomite having a content of free calcium oxide of 1.2% by weight or lower and a content of free magnesium oxide of 8% by weight or higher.

Japanese Laid-open Patent Publication No. 2010-214254A (Patent Document 3) discloses a heavy metal elution-suppressing material including half-fired dolomite obtained by half-firing dolomite for which the half-firing is carried out under firing conditions in which magnesium carbonate in dolomite is decarboxylated and calcium carbonate in dolomite is not decarboxylated at a specific carbon dioxide partial pressure and in which the half-fired dolomite includes magnesium oxide and calcium carbonate.

Japanese Laid-open Patent Publication No. 2008-80223A (Patent Document 4) discloses a fluoride ion-trapping material for which dolomite is heated at a temperature in a range of 600° C. to 880° C. and in which the content of an undecomposed carbon dioxide component is in a range of 1.5% by weight to 47% by weight.

However, for the above dolomite materials of the related art, the regulations regarding fired dolomite serve as indirect indexes of the amount of the undecomposed carbon dioxide component, free calcium oxide, magnesium, or the like, and, in a case in which the amount of a dolomite phase in a dolomite mineral as a starting material is significantly small, there are cases in which the content of free magnesium oxide is not satisfied or, when a raw material is used, the amount of the undecomposed carbon dioxide component changes, and the regulations may become inapplicable depending on the dolomite mineral as the starting material.

Furthermore, in Japanese Laid-open Patent Publication No. 2010-214254A, dolomite is fired after the carbon dioxide partial pressure is adjusted to be in a specific range, and thus there is a problem of an increase in facility investment or production costs unless a special firing furnace is used.

Meanwhile, when dolomite is fired, thermal decomposition represented by the following formula is caused and thus dolomite has adsorption property of heavy metal and the like.

CaMg(CO₃)₂␣MgO+CaCO₃+CO₂ (1)

When dolomite is fired, a dolomite phase (CaMg(CO₃)₂ phase), a MgO phase, and a CaCO₃ phase coexist in half-fired dolomite, and insolubilization property, adsorption property, and elution-suppressing property with respect to a variety of heavy metal and the like, vary depending on the content proportions of these crystal phases.

In addition, since the dolomite mineral as a raw material is generally produced in a biphase mixture state of a dolomite phase and a calcium carbonate phase and the content ratio of the dolomite phase significantly varies depending on localities, there is a problem in that appropriate firing conditions vary depending on raw materials.

Furthermore, in order to effectively adsorb heavy metal, halogen and metalloid, several elements can be considered, and the specific surface area of a dolomite-based material is also one of them. Therefore, it is expected that heavy metal, halogen and metalloid can be effectively adsorbed by efficiently increasing the specific surface area of a dolomite-based material.

### SUMMARY OF THE INVENTION

An object of the present invention is to solve the above problems and provide a dolomite-based material having a high specific surface area which is half-fired dolomite having a high specific surface area regardless of the difference in composition caused by the difference in localities of a dolomite mineral as a raw material, and setting of firing conditions such as temperature, and the like.

In addition, another object of the present invention is to provide a method for preparing a dolomite-based material having a high specific surface area in order to obtain the dolomite-based material in which the specific surface area of raw dolomite material increases regardless of the difference in composition caused by the difference in localities of a dolomite mineral as a raw material, and setting of firing conditions such as temperature, and the like.

In addition, still another object of the present invention is to provide a method for controlling a quality of a dolomite-based material having the high specific surface area with which the quality of dolomite is controlled so that the specific surface area of the dolomite increases regardless of the difference in composition caused by the difference in localities of a dolomite mineral as a raw material, and setting of firing conditions such as temperature, and the like.

The present invention is achieved by finding that there is a close relationship between the content of a dolomite phase remaining in a fired-dolomite material and the specific surface area varying due to firing and analyzing and determining the residual amount of the dolomite phase in the fired-dolomite material by a specific method.

That is, a dolomite-based material having a high specific surface area of the present invention is a half-fired dolomite, in which a content of a residual CaMg(CO₃)₂ phase in the half-fired dolomite, which is analyzed using a Rietveld method by means of powder X-ray diffraction, is 0.4δ×δ35.4 (wt %).

Preferably, the dolomite-based material having a high specific surface area of the present invention further comprises ferrous sulfate.

In addition, a method for preparing a dolomite-based material having a high specific surface area of the present invention comprises firing dolomite so that a content of a residual CaMg(CO₃)₂ phase in the obtained dolomite-based material, which is analyzed using a Rietveld method by means of powder X-ray diffraction, is 0.4δ×δ35.4 (wt %).

Preferably, the method for preparing a dolomite-based material having a high specific surface area of the present invention further comprises blending ferrous sulfate in the obtained dolomite-based material.

A method for controlling a quality of a dolomite-based material having a high specific surface area of the present invention comprises adjusting a residual amount of a residual CaMg(CO₃)₂ phase in the obtained dolomite-based material by firing dolomite so that a content of residual CaMg(CO₃)₂ phase in the obtained dolomite-based material, which is analyzed using a Rietveld method by means of powder X-ray diffraction of the dolomite fired substance, is 0.4δ×δ35.4 (wt %).

A method for adsorbing heavy metal, halogen and metalloid comprises using the dolomite-based material having a high specific area of present inventions.

In the present invention, due to the finding that there is a close relationship between the specific surface area of dolomite and the content of a residual dolomite phase in a dolomite fired material, the dolomite-based material of the present invention can have a high specific surface area regardless of the difference in composition caused by the difference in localities of a dolomite mineral as a raw material, adjustment of firing conditions such as the firing temperature and the like, by specifying the content of a residual dolomite phase in half-fired dolomite and becomes capable of effectively exhibiting the heavy metal, halogen and metalloid adsorption properties of dolomite.

In addition, it becomes possible to facilitate the control of quality with which the specific surface area of the dolomite material is maintained at a high level so that dolomite has a high specific surface area.

In addition, the method for preparing a dolomite-based material having a high specific surface area of the present invention enables appropriate production of a dolomite-based material having a high specific surface area which is half-fired dolomite without any need of a special apparatus or the like.

The dolomite-based material having a high specific surface area of the present invention becomes capable of effectively removing heavy metal, halogen and metalloid in soils or waste water.

Here, the substances that can be adsorbed and removed are heavy metal, halogen and metalloid. The heavy metal can be exemplified by one or more of chromium, lead, cadmium, and the like, and the halogen can be exemplified by chlorine, fluorine, and the like, and metalloid can be exemplified by one or more of arsenic, boron and the like, but the heavy metal, the halogen and the metalloid are not limited thereto.

### BRIEF DESCRIPTION OF THE DRAWINGS

FIG. 1 is a line graph illustrating a content and a specific surface area of a residual dolomite phase in a fired-dolomite material for which an example of a dolomite-based material is used.

FIG. 2 is a line graph illustrating the content and the specific surface area of the residual dolomite phase in a fired-dolomite material for which another example of the dolomite-based material is used.

FIG. 3 is a line graph illustrating the content and the specific surface area of the residual dolomite phase in a fired-dolomite material for which still another example of the dolomite-based material is used.

FIG. 4 is a line graph illustrating the content and the specific surface area of the residual dolomite phase in a fired-dolomite material for which still another example of the dolomite-based material is used.

FIG. 5 is a line graph illustrating the content and the specific surface area of the residual dolomite phase in a fired-dolomite material for which still another example of the dolomite-based material is used.

FIG. 6 is a line graph illustrating the content of the residual dolomite phase in a fired-dolomite material for which an example of the dolomite-based material is used, and an adsorption removal ratio of heavy metal, halogen and metalloid.

FIG. 7 is a line graph illustrating the content of the residual dolomite phase in a fired-dolomite material for which another example of the dolomite-based material is used, and the adsorption removal ratio of heavy metal, halogen and metalloid.

FIG. 8 is a line graph illustrating the content of the residual dolomite phase in a fired-dolomite material for which still another example of the dolomite-based material is used, and the adsorption removal ratio of heavy metal, halogen and metalloid.

FIG. 9 is a line graph illustrating the content of the residual dolomite phase in a fired-dolomite material for which still another example of the dolomite-based material is used, and the adsorption removal ratio of heavy metal, halogen and metalloid.

FIG. 10 is a line graph illustrating the content of the residual dolomite phase in a fired-dolomite material for which still another example of the dolomite-based material is used, and the adsorption removal ratio of heavy metal, halogen and metalloid.

FIG. 11 is a view illustrating a relationship between the specific surface area of the fired-dolomite material and the residual amount of the dolomite phase which vary depending on localities of a raw dolomite material.

### DETAILED DESCRIPTION OF THE INVENTION

The present invention will be described using the following preferred examples, but is not limited thereto.

A dolomite-based material of the present invention is half-fired dolomite, in which the content of a residual CaMg(CO₃)₂ phase in the half-fired dolomite, which is analyzed using a Rietveld method by means of powder X-ray diffraction, is 0.48δ×δ35.4 (wt %) and thus has a high specific surface area regardless of the localities of a dolomite raw material.

In the present invention, since there is a correlation between the content and the specific surface area of a residual dolomite phase in the fired dolomite, dolomite has a high specific surface area and becomes excellent heavy metal, halogen and metalloid adsorption regardless of the difference in composition caused by the difference in localities of a dolomite mineral as a raw material, adjustment of firing conditions such as the firing temperature, and the like by determining the amount of a CaMg(CO₃)₂ phase which is a dolomite phase in the fired-dolomite material and adjusting the amount to be a residual amount in the above specific range.

Any of raw dolomite material can be used as raw dolomite material in the present invention, and the locality or the composition of the raw dolomite material does not matter.

Dolomite has a double salt structure in which the molar ratio between limestone (CaCO₃) and magnesite (MgCO₃) reaches 1:1, Ca²⁺ions and Mg²⁺ions form layers with each other with a CO₃²⁻group therebetween, and, generally, the proportion of magnesium carbonate is in a range of 10 wt % to 45 wt %. Since a large amount of dolomite is present in Japan, an absorbent for heavy metal, halogen and metalloid prepared using the dolomite is also advantageous in views of costs or environmental load.

When dolomite is fired, a decomposition reaction represented by the following formula is caused:

CaMg(CO₃)₂␣MgO+CaCO₃+CO₂ (1)

It is considered that the thermal decomposition of dolomite by means of firing forms fine pores and heavy metal adsorption property is exhibited.

In the present invention, half-fired dolomite in which the content of a residual CaMg(CO₃)₂ phase in the half-fired dolomite obtained by firing dolomite, which is analyzed using the Rietveld method by means of powder X-ray diffraction, is 0.4δ×δ35.4 (wt %) and preferably 1.8δ×δ17.4 (wt %), can have excellent heavy metal, halogen and metalloid adsorption properties.

In a case in which the content of the residual CaMg(CO₃)₂ phase is smaller than 0.4 wt % or larger than 35.4 wt %, the obtained specific surface area is small.

Unlike a TG-DSC method, the powder X-ray diffraction method is capable of accurately analyzing the amounts of a CaMg(CO₃)₂ phase, a CaCO₃ phase, and a MgO phase in the half-fired dolomite, and thus it becomes possible to accurately determine the amount of the residual CaMg(CO₃)₂ phase in the half-fired dolomite.

In the present invention, preferably, further comprises a ferrous compound, and examples of the ferrous compound comprise ferrous chloride and ferrous sulfate.

Regarding the blended amount of the ferrous compound, the weight ratio between the ferrous compound and half-fired dolomite in which the content of the residual CaMg(CO₃)₂ phase is 0.4δ×δ35.4 (wt %) is in a range of 5:5 to 9:1 and preferably 9:1.

When the dolomite-based material contains the ferrous compound, high specific surface area is also obtained. Due to its reduction action, it is possible to more effectively insolubilize heavy metal, halogen and metalloid, and it becomes possible to remove heavy metal, halogen and metalloid from contaminated waste water or contaminated soils.

In addition, in the method for preparing a dolomite-based material of the present invention, dolomite is fired so that the content of the residual CaMg(CO₃)₂ phase in the obtained dolomite-based material, which is analyzed using the Rietveld method by means of powder X-ray diffraction, is 0.4δ×δ35.4 (wt %), whereby a high specific surface area can be provided, and thus it is possible to prepare dolomite-based material having a high specific surface area.

The temperature at which dolomite is fired is not particularly limited, and dolomite can be fired at an ordinary temperature at which dolomite is fired so as to prepare half-fired dolomite, for example, a temperature in a range of 650° C. to 1000° C. The firing duration is also not limited as long as dolomite is fired so that the content of the residual CaMg(CO₃)₂ phase is 0.4δ×δ35.4 (wt %).

In a process of firing dolomite, when half-fired dolomite is selected at a point in time at which the content of the residual CaMg(CO₃)₂ phase is 0.4δ×δ35.4 (wt %), the dolomite-based material having high specific surface area of the present invention can be obtained.

In addition, when the content of the residual CaMg(CO₃)₂ phase in the fired-dolomite material analyzed using the Rietveld method by means of powder X-ray diffraction of the fired-dolomite material is adjusted to 0.4δ×δ35.4 (wt %), it becomes possible to facilitate quality control so that dolomite has high specific surface area.

When the dolomite-based material having a high specific surface area of the present invention is brought into contact with contaminated soils or contaminated waste water, it is possible to adsorb and remove heavy metal, halogen and metalloid in the contaminated soils or the contaminated waste water.

As a contact method, a well-known arbitrary method is applicable, and examples thereof include mixing of the dolomite-based material of the present invention and soils and a method in which the dolomite-based material of the present invention is added into and stirred with waste water. In addition, in a case in which the dolomite-based material of the present invention is added into contaminated waste water, it is also possible to collect heavy metal, halogen and metalloid by adding an agglomerating agent and conducting solid-liquid separation.

### EXAMPLES

The present invention will be described by the following examples and comparative examples.

Five kinds of dolomite from different A to E localities were fired at 800° C. in the air for 10 minutes to 120 minutes, and, during that period, a fired-dolomite material was obtained every 10 minutes from the beginning of the firing. For the respective fired-dolomite material, the contents of a residual CaMg(CO₃)₂ phase in the respective fired-dolomite material were analyzed by the powder X-ray diffraction Rietveld method under the below conditions.

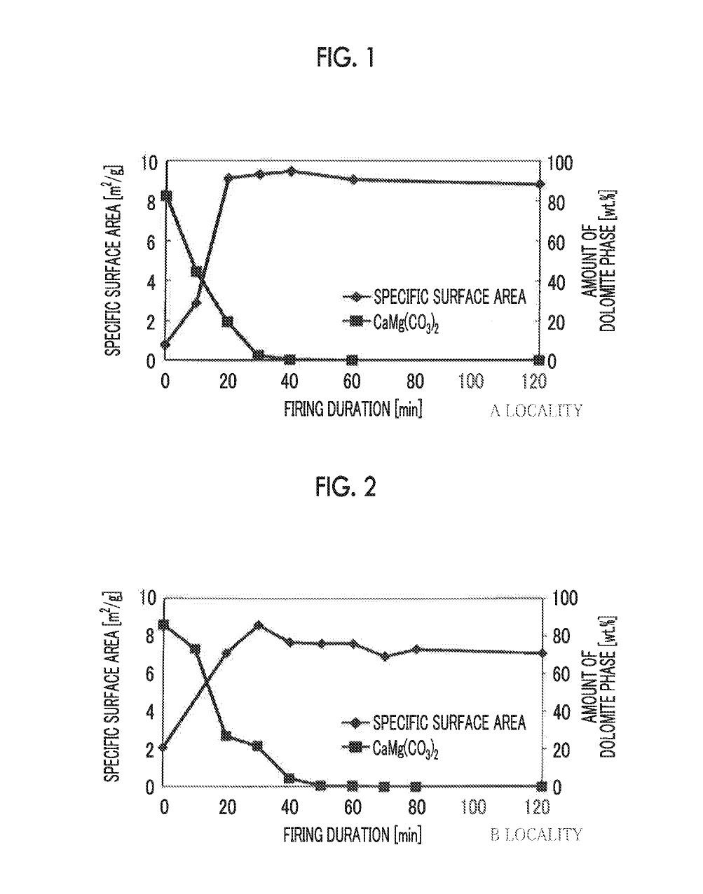

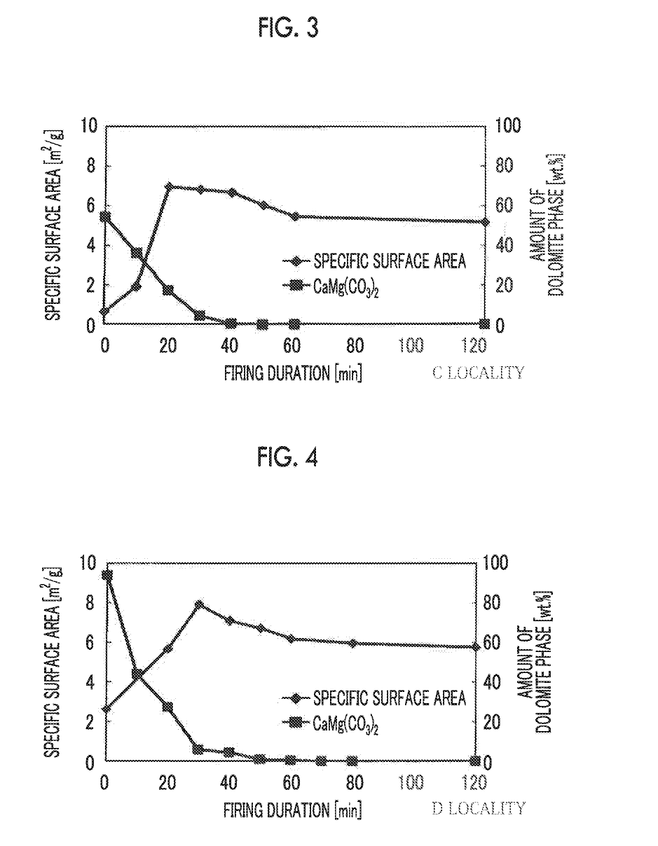

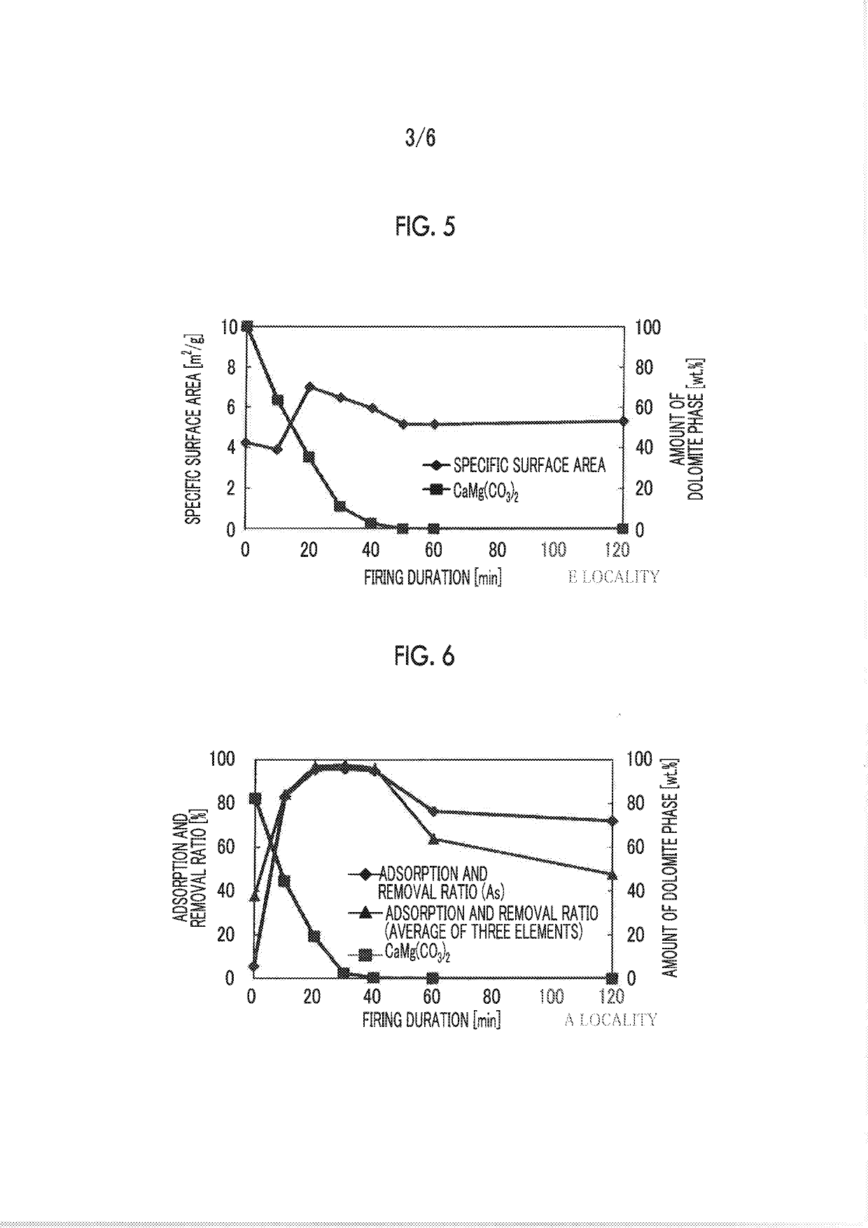

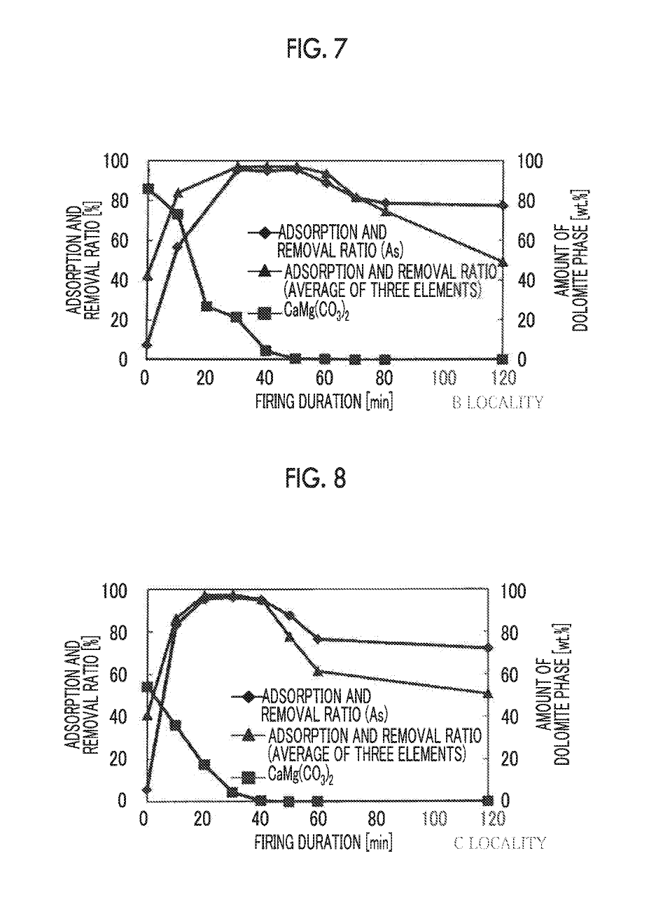

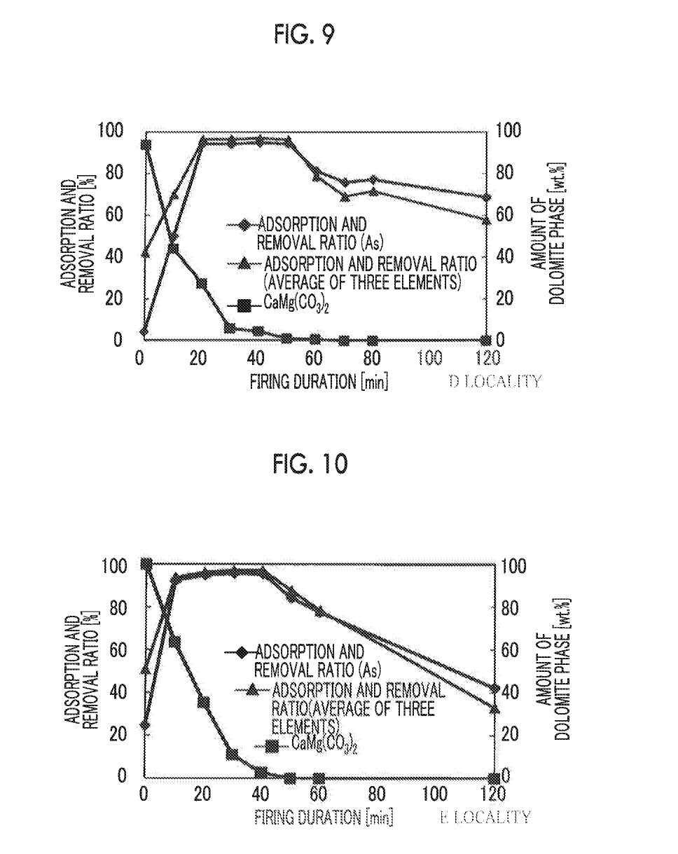

The results are respectively shown in Tables 1 to 5 and FIGS. 1 to 5 and 6 to 10 (dolomite from the A locality is in Table 1 and FIGS. 1 and 6; dolomite from the B locality is in Table 2 and FIGS. 2 and 7; dolomite from the C locality is in Table 3 and FIGS. 3 and 8; dolomite from the D locality is in Table 4 and FIGS. 4 and 9; and dolomite from the E locality is in Table 5 and FIGS. 5 and 10) .

TABLE 1
Amount determination results of individual phases
by means of Rietveld analysis (wt. %)

| Firing duration | | | | | | |
|---|---|---|---|---|---|---|
| [min] | CaMg(CO₃)₂ | CaCO₃ | MgO | CaO | Ca(OH)₂ | SiO₂ |
| 0 | 82.5 | 17.5 | 0 | 0 | 0 | 0 |
| 10 | 44.6 | 55.6 | 0 | 0 | 0 | 0 |
| 20 | 19.4 | 63.8 | 16.8 | 0 | 0 | 0 |
| 30 | 2.6 | 76.5 | 20.9 | 0 | 0 | 0 |
| 40 | 0.5 | 77.0 | 22.5 | 0 | 0 | 0 |
| 60 | 0.1 | 80.7 | 17.9 | 1.1 | 0.1 | 0 |
| 120 | 0 | 66.9 | 28.2 | 3.9 | 1.0 | 0 |

TABLE 2
Amount determination results of individual phases
by means of Rietveld analysis (wt. %)

| Firing duration | | | | | |
|---|---|---|---|---|---|
| [min] | CaMg(CO₃)₂ | CaCO₃ | MgO | CaO | SiO₂ |
| 0 | 85.9 | 11.7 | 0 | 0 | 2.3 |
| 10 | 73.2 | 24.6 | 0 | 0 | 2.2 |
| 20 | 26.9 | 64.5 | 5.0 | 0 | 3.7 |
| 30 | 21.5 | 70.1 | 5.6 | 0 | 2.8 |
| 40 | 4.5 | 79.6 | 12.2 | 0 | 3.6 |
| 50 | 0.5 | 81.9 | 13.1 | 0 | 4.6 |
| 60 | 0.3 | 80.2 | 15.3 | 0.3 | 4.0 |
| 70 | 0 | 75.0 | 20.1 | 1.1 | 3.8 |
| 80 | 0 | 71.7 | 20.4 | 3.3 | 4.6 |
| 120 | 0 | 68.3 | 20.2 | 7.9 | 3.7 |

TABLE 3
Amount determination results of individual phases
by means of Rietveld analysis (wt. %)

| Firing duration | | | | | |
|---|---|---|---|---|---|
| [min] | CaMg(CO₃)₂ | CaCO₃ | MgO | CaO | SiO₂ |
| 0 | 54.3 | 44.3 | 0 | 0 | 1.4 |
| 10 | 36.0 | 55.8 | 0 | 0 | 1.3 |
| 20 | 17.4 | 74.3 | 7.2 | 0 | 1.0 |
| 30 | 4.4 | 86.5 | 7.9 | 0 | 1.2 |
| 40 | 0.4 | 83.5 | 14.6 | 0 | 1.5 |
| 50 | 0 | 81.6 | 15.8 | 0.8 | 1.8 |
| 60 | 0 | 83.3 | 12.3 | 2.4 | 2.0 |
| 120 | 0 | 61.6 | 12.7 | 24.0 | 1.6 |

TABLE 4
Amount determination results of individual phases
by means of Rietveld analysis (wt. %)

| Firing duration | | | | | |
|---|---|---|---|---|---|
| [min] | CaMg(CO₃)₂ | CaCO₃ | MgO | CaO | SiO₂ |
| 0 | 93.9 | 5.9 | 0 | 0 | 0.2 |
| 10 | 44.1 | 48.3 | 7.4 | 0 | 0.2 |
| 20 | 27.5 | 60.9 | 11.3 | 0 | 0.3 |
| 30 | 5.9 | 80.3 | 13.5 | 0 | 0.3 |
| 40 | 4.5 | 81.9 | 13.3 | 0 | 0.3 |
| 50 | 1.1 | 84.7 | 13.9 | 0 | 0.3 |
| 60 | 0.6 | 84.2 | 14.9 | 0 | 0.3 |
| 70 | 0 | 76.5 | 21.7 | 1.6 | 0.1 |
| 80 | 0 | 76.9 | 19.5 | 3.3 | 0.3 |
| 120 | 0 | 61.8 | 21.9 | 16.1 | 0.1 |

TABLE 5
Amount determination results of individual phases
by means of Rietveld analysis (wt. %)

| Firing duration | | | | | |
|---|---|---|---|---|---|
| [min] | CaMg(CO₃)₂ | CaCO₃ | MgO | CaO | SiO₂ |
| 0 | 100 | 0 | 0 | 0 | 0 |
| 10 | 63.5 | 32.0 | 4.4 | 0 | 0 |
| 20 | 35.4 | 54.9 | 8.7 | 0 | 0 |
| 30 | 11.1 | 77.1 | 11.8 | 0 | 0 |
| 40 | 2.8 | 83.9 | 13.3 | 0 | 0 |
| 50 | 0 | 87.7 | 11.8 | 0.5 | 0 |
| 60 | 0 | 84.4 | 15.0 | 0.6 | 0 |
| 120 | 0 | 66.6 | 24.1 | 9.6 | 0 |

The measurement conditions of the powder X-ray diffraction are as described below.

Apparatus name: PANalytical X′Pert Pro MPD

Rietveld analysis software: PANalytical X′Pert HighScore Plus

Measurement conditions

Bulb: Cu-Kα

Tube voltage: 45 kV

Current: 40 mA

Divergence slit: variable (12mm)

Anti-Scatter slit (incidence side): none

Solar slit (incidence side): 0.04 Rad

Receiving slit: none

Anti-Scatter slit (light receiving side): variable (12mm)

Solar slit (light receiving side): 0.04 Rad

Scanning field: 2θ=5˜90°

Step scanning: 0.008°

Continuous scanning time: 0.10°/sec

The specific surface areas of the respective fired-dolomite material obtained from the respective A to E localities were measured. The results are shown in Tables 6 to 10 and FIGS. 1 to 5 (dolomite from the A locality is in FIG. 1; dolomite from the B locality is in FIG. 2; dolomite from the C locality is in FIG. 3; dolomite from the D locality is in FIG. 4; and dolomite from the E locality is in FIG. 5).

In addition, Tables 6 to 10 show the fine pore volumes and the fine pore radii of the fired-dolomite material obtained from the respective A to E localities.

Meanwhile, the specific surface areas, the fine pore volumes, and the fire pore radii were measured by the following methods.

⊕ Nitrogen adsorption method

Pretreatment method: the fired-dolomite material was degassed in a vacuum at 120° C. for eight hours.

Measurement method: The adsorption and desorption isotherm of nitrogen was measured by a constant volume method.

Adsorption temperature: 77 K

Sectional area of adsorbate: 0.162 nm²

Adsorbate: nitrogen

Equilibrium holding duration: 150 sec. *1

Saturated vapor pressure: actually measured

*1: The holding duration after the adsorption equilibrium state (a state in which the pressure change during adsorption and desorption reached a predetermined value or lower) was reached

Specific surface area: calculated by the BET method (JIS Z 8830:2013)

Fine pore volume and fine pore radius: calculated by the BJH method (JIS Z 8831-2:2010)

Measurement apparatus: BELSORP-mini (manufactured by MicrotracBEL Corp.)

Pretreatment apparatus: BELSORP-vac II (manufactured by MicrotracBEL Corp.)

Meanwhile, the nitrogen BET method refers to a method in which the adsorption isotherm is measured by adsorbing and desorbing nitrogen as an adsorption molecule to an adsorbent and the measured data was analyzed on the basis of a BET method represented by Formula (1) below, and the specific surface area and the fine pore volume can be calculated on the basis of this method.

Specifically, in a case of a value of the specific surface area is calculated by the nitrogen BET method, first, the adsorption isotherm is measured by adsorbing nitrogen as an adsorption molecule to the adsorbent. In addition, [p/{Va(p0−p)}] is calculated on the basis of Formula(1) below or Formula(1′) obtained by modifying Formula(1) and is plotted with respect to the equilibrium relative pressure (p/p0). In addition, with an assumption that the plot is a straight line, the slope s (=[(C-1)/(C⊕Vm)]) and the intercept i(=[1/(C⊕Vm)]) are calculated on the basis of the least-square method. In addition, Vm and C are calculated from the obtained slope s and intercept i on the basis of Formula (2-1) and Formula (2-2) below. Furthermore, the specific surface area can be obtained by calculating the specific surface area asBET from Vm on the basis of Formula (3) below.

Va=(Vm⊕C⊕p)/[(p0−p){1+(C−1)(p/p0)}]⊕⊕⊕ (1)

[p/{Va(p0−p)}]=[(C−1)/(C⊕Vm)](p/p0)+[1/(C⊕Vm)]⊕⊕⊕ (1′)

Vm=1/(s+i) ⊕⊕⊕ (2-1)

C=(s/i)+1 ⊕⊕⊕ (2-2)

asBET=(Vm⊕L⊕ [symbol] )/22414 ⊕⊕⊕ (3)

Here, in the above formulas, Va represents the adsorption amount, Vm represents the adsorption amount of a monomolecular layer, p represents the pressure of nitrogen during equilibrium, p0 represents the saturated vapor pressure of nitrogen, L represents Avogadro's number, and [symbol] represents the adsorption sectional area of nitrogen.

In a case in which the fine pore volume Vp is calculated by the nitrogen BET method, for example, the adsorption data of the obtained adsorption isotherm is linearly interpolated, and the adsorption amount V at a relative pressure set at the fine pore volume calculating relative pressure is obtained. The fine pore volume Vp can be calculated from the adsorption amount V on the basis of Formula (4) below. Meanwhile, the fine pore volume based on the nitrogen BET method will be simply referred to as the “fine pore volume”.

Vp=(V/22414)·(Mg/ [symbol] g) ⊕⊕⊕ (4)

Here, in the above formula (4), V represents the adsorption amount at the relative pressure, Mg represents the molecular weight of nitrogen, and [symbol] g represents the density of nitrogen.

The pore diameter of a mesopore can be calculated as a fine pore distribution form from the fine pore volume change ratio with respect to the pore diameter on the basis of, for example, the BJH method. The BJH method refers to a method that is widely used as a fine pore distribution analyzing method. In a case in which the fine pore distribution is analyzed on the basis of the BJH method, first, the desorption isotherm is obtained by adsorbing and desorbing nitrogen as an adsorption molecule to an adsorbent. In addition, on the basis of the obtained desorption isotherm, the thickness of an adsorption layer when adsorption molecules (for example, nitrogen) are desorbed in a stepwise manner from a state in which fine pores are filled with the adsorption molecules and the inner diameters (twice the core radius) of pores generated at this moment are obtained, the fine pore radius rp is calculated on the basis of Formula(5) below, and the fine pore volume is calculated on the basis of Formula (6) below.

Furthermore, a fine pore radius curve can be obtained by plotting the fine pore volume change ratio (Vp/drp) vs. the fine pore diameter (2 rp) from the fine pore radius and the fine pore. In addition, the peak of the fine pore radius in the fine pore radius curve is referred to as the peak fine pore radius.

rp=t+rk ⊕⊕⊕ (5)

Vpn=Rn⊕dVn−Rn⊕dtn⊕c⊕©Apj ⊕⊕⊕ (6)

Here, Rn=rpn2/(rkn−1+dtn)2 ⊕⊕⊕ (7)

In the above formulas, rp represents the fine pore radius, rk represents the core radius (the inner diameter/2) in a case in which an adsorption layer having a thickness t is adsorbed to the inner wall of a fine pore having a fine pore radius rp at the pressure, Vpn represents the fine pore volume when nitrogen desorption occurs for the n^{th} time, dVn represents the change amount at that time, dtn represents the change amount of the thickness to of the adsorption layer when nitrogen desorption occurs for the n^{th} time, rkn represents the core radius at that time, c represents a fixed value, and rpn represents the fine pore radius when nitrogen desorption occurs for the n^{th} time.

In addition, ©Apj represents the integrated value of the areas of the wall surfaces of the fine pores from j=1 to j=n−1.

TABLE 6
Measurement results of specific surface area by means of BET method and
measurement results of fine pore distribution by means of BJH method

| | Firing duration [min] | | | | | | | |
|---|---|---|---|---|---|---|---|---|
| | 0 | 10 | 20 | 30 | 40 | 60 | 120 | |
| Fine pore | 5.96E−03 | 0.025196 | 0.047644 | 0.063972 | 0.061209 | 0.068285 | 0.088304 | [cm³ g⁻¹] |
| volume | | | | | | | | |
| Peak fine | 25.55 | 14.13 | 14.13 | 16.29 | 10.65 | 16.29 | 22.07 | [nm] |
| pore radius | | | | | | | | |
| Specific | 0.7877 | 2.8725 | 9.132 | 9.3304 | 9.487 | 9.0668 | 8.8397 | [m² g⁻¹] |
| surface area | | | | | | | | |

TABLE 7
Measurement results of specific surface area by means of BET method and
measurement results of fine pore distribution by means of BJH method

| | Firing duration [min] | | | | | | | | | |
|---|---|---|---|---|---|---|---|---|---|---|
| | 0 | 20 | 30 | 40 | 50 | 60 | 70 | 80 | 120 | |
| Fine pore | 0.014027 | 0.051726 | 0.065583 | 0.065866 | 0.072277 | 0.067748 | 0.07572 | 0.078359 | 0.079244 | [cm³ g⁻¹] |
| volume | | | | | | | | | | |
| Peak fine | 1.64 | 12.24 | 16.29 | 22.07 | 22.07 | 22.07 | 25.55 | 25.55 | 29.5 | [nm] |
| pore radius | | | | | | | | | | |
| Specific | 2.0593 | 7.0981 | 8.5843 | 7.6638 | 7.5885 | 7.5881 | 6.9176 | 7.2947 | 7.083 | [m² g⁻¹] |
| surface area | | | | | | | | | | |

TABLE 8
Measurement results of specific surface area by means of BET method and
measurement results of fine pore distribution by means of BJH method

| | Firing duration [min] | | | | | | | | |
|---|---|---|---|---|---|---|---|---|---|
| | 0 | 10 | 20 | 30 | 40 | 50 | 60 | 120 | |
| Fine pore | 0.0053458 | 0.015591 | 0.045684 | 0.053017 | 0.055505 | 0.060191 | 0.065818 | 0.073634 | [cm³ g⁻¹] |
| volume | | | | | | | | | |
| Peak fine | 1.21 | 12.24 | 12.24 | 14.13 | 16.29 | 22.07 | 25.55 | 29.5 | [nm] |
| pore radius | | | | | | | | | |
| Specific | 0.634 | 1.9176 | 6.9776 | 6.8409 | 6.6865 | 6.0417 | 5.4686 | 5.1602 | [m² g⁻¹] |
| surface area | | | | | | | | | |

TABLE 9
Measurement results of specific surface area by means of BET method and
measurement results of fine pore distribution by means of BJH method

| | Firing duration [min] | | | | | | | | |
|---|---|---|---|---|---|---|---|---|---|
| | 0 | 20 | 30 | 40 | 50 | 60 | 80 | 120 | |
| Fine pore | 0.015366 | 0.048914 | 0.071484 | 0.072267 | 0.071558 | 0.071558 | 0.070661 | 0.056105 | [cm³ g⁻¹] |
| volume | | | | | | | | | |
| Peak fine | 1.21 | 22.07 | 29.5 | 29.5 | 29.5 | 33.81 | 39.01 | 1.64 | [nm] |
| pore radius | | | | | | | | | |
| Specific | 2.6332 | 5.6768 | 7.9209 | 7.0941 | 6.7235 | 6.1906 | 5.9638 | 5.7557 | [m² g⁻¹] |
| surface area | | | | | | | | | |

TABLE 10
Measurement results of specific surface area by means of BET method and
measurement results of fine pore distribution by means of BJH method

| | Firing duration [min] | | | | | | | | |
|---|---|---|---|---|---|---|---|---|---|
| | 0 | 10 | 20 | 30 | 40 | 50 | 60 | 120 | |
| Fine pore | 0.02838 | 0.035596 | 0.065915 | 0.06429 | 0.063236 | 0.056804 | 0.056804 | 0.050104 | [cm³ g⁻¹] |
| volume | | | | | | | | | |
| Peak fine | 6.95 | 22.07 | 22.07 | 29.5 | 29.5 | 33.81 | 33.81 | 46.13 | [nm] |
| pore radius | | | | | | | | | |
| Specific | 4.255 | 3.9133 | 7.0124 | 6.4787 | 5.9666 | 5.1708 | 5.1708 | 5.3259 | [m² g⁻¹] |
| surface area | | | | | | | | | |

Each of the fired-dolomite material (1 g) was added to 100 mg of respective solutions containing arsenic (As), fluorine (F), or lead (Pb) (5 mg/l, respectively) which were prepared using respective reagents shown in Table 11, and uniformly mixing with four-hour vibration was conducted.

TABLE 11

| Element | Reagent |
|---|---|
| As(III) | NaAsO₂ |
| F | NaF |
| Pb | Pb(NO₃)₂ |

After that, the mixtures were separated into solid and liquid by solid-liquid separation, the adsorption removal ratio of arsenic in the solution, and the average removal ratios of the arsenic, fluorine, and lead were calculated from the residual amounts of arsenic, fluorine, and lead remaining in the respective solutions, by the methods shown in Table 12.

Meanwhile, for lead, an ICP emission spectroscopic analysis method in the case of an analysis of an mg/l order is used, and electrothermal atomizer atomic absorption spectrometry in the case of an analysis of a [symbol] g/l order is used.

In addition, the pH and oxidation-reduction potential (ORP) of a filtrate were measured using a desktop pH meter: F-73 manufactured by Horiba, Ltd. (pH electrode: 9615S-10D, ORP electrode: 9300-10D).

TABLE 12

| Subject element | Analysis method | |
|---|---|---|
| As | JIS K 0102-2008 61.2 | Hydride generation atomic |
| | | absorption spectrometry |
| F | JIS K 0170-2011 6 | Lanthanum/Alizarin |
| | | Complexone method |
| Pb | JIS K 0102-2008 54.2 | Electrothermal atomizer atom- |
| | | ic absorption spectrometry |
| | JIS K 0102-2008 54.3 | ICP emission spectroscopic |
| | | analysis method |

The obtained results are respectively shown in Tables 13 to 17 and FIGS. 6 to 10 (dolomite from the A locality is in FIG. 13 and FIG. 6; dolomite from the B locality is in FIG. 14 and FIG. 7; dolomite from the C locality is in FIG. 15 and FIG. 8; dolomite from the D locality is in FIG. 16 and FIG. 9; and dolomite from the E locality is in FIG. 17 and FIG. 10).

TABLE 13
Adsorption test

| Firing duration | Adsorption removal ratio [%] | | | | Properties of filtrate | |
|---|---|---|---|---|---|---|
| [min] | As(III) | F | Pb | Average | pH | ORP[mV] |
| 0 | 5.7 | 9.8 | 97.9 | 37.8 | 8.0 | 280 |
| 10 | 83.4 | 83.1 | 86.9 | 84.5 | 9.4 | 190 |
| 20 | 95.6 | 97.9 | 97.8 | 97.1 | 10.8 | 202 |
| 30 | 96.0 | 97.9 | 99.6 | 97.8 | 10.8 | 204 |
| 40 | 95.1 | 95.8 | 97.9 | 96.3 | 11.2 | 180 |
| 60 | 76.5 | 35.1 | 80.0 | 63.9 | 12.0 | 92 |
| 120 | 72.1 | 29.5 | 41.2 | 47.6 | 12.3 | 42 |

TABLE 14
Adsorption test

| Firing duration | Adsorption removal ratio [%] | | | | Properties of filtrate | |
|---|---|---|---|---|---|---|
| [min] | As(III) | F | Pb | Average | pH | ORP[mV] |
| 0 | 7.4 | 21.3 | 99.6 | 42.8 | 8.8 | 276 |
| 10 | 56.7 | 96.0 | 99.6 | 84.1 | 9.1 | 249 |
| 30 | 95.7 | 96.2 | 99.6 | 97.2 | 10.5 | 213 |
| 40 | 95.0 | 97.2 | 99.6 | 97.3 | 10.7 | 207 |
| 50 | 95.7 | 96.4 | 99.6 | 97.2 | 10.9 | 201 |
| 60 | 89.0 | 93.2 | 99.5 | 93.9 | 11.4 | 171 |
| 70 | 81.5 | 68.5 | 95.3 | 81.8 | 12.0 | 118 |
| 80 | 78.8 | 60.9 | 84.4 | 74.7 | 12.3 | 94 |
| 120 | 77.5 | 13.7 | 56.7 | 49.3 | 12.6 | 71 |

TABLE 15
Adsorption test

| Firing duration | Adsorption removal ratio [%] | | | | Properties of filtrate | |
|---|---|---|---|---|---|---|
| [min] | As(III) | F | Pb | Average | pH | ORP[mV] |
| 0 | 5.7 | 19.0 | 97.9 | 40.8 | 9.2 | 279 |
| 10 | 83.4 | 77.6 | 97.9 | 86.3 | 10.8 | 196 |
| 20 | 95.6 | 96.9 | 99.6 | 97.4 | 10.9 | 197 |
| 30 | 96.4 | 96.6 | 99.6 | 97.5 | 11.0 | 197 |
| 40 | 95.1 | 91.4 | 99.6 | 95.4 | 11.3 | 186 |
| 50 | 87.7 | 54.9 | 90.5 | 77.7 | 11.9 | 142 |
| 60 | 76.5 | 35.1 | 72.8 | 61.5 | 12.6 | 97 |
| 120 | 72.1 | 29.5 | 50.5 | 50.7 | 12.1 | 58 |

TABLE 16
Adsorption test

| Firing duration | Adsorption removal ratio [%] | | | | Properties of filtrate | |
|---|---|---|---|---|---|---|
| [min] | As(III) | F | Pb | Average | pH | ORP[mV] |
| 0 | 4.4 | 23.5 | 99.6 | 42.5 | 9.3 | 259 |
| 10 | 50.3 | 60.4 | 99.6 | 70.1 | 9.8 | 212 |
| 20 | 94.5 | 95.5 | 99.6 | 96.5 | 10.6 | 195 |
| 30 | 94.3 | 96.0 | 99.6 | 96.7 | 10.8 | 183 |
| 40 | 94.9 | 96.8 | 99.6 | 97.1 | 10.8 | 146 |
| 50 | 94.4 | 95.5 | 99.5 | 96.5 | 11.0 | 145 |
| 60 | 81.3 | 61.5 | 93.7 | 78.8 | 11.9 | 102 |
| 70 | 76.0 | 49.2 | 82.3 | 69.2 | 12.0 | 92 |
| 80 | 77.3 | 50.4 | 87.2 | 71.6 | 12.1 | 85 |
| 120 | 68.7 | 45.4 | 59.2 | 57.7 | 12.6 | 53 |

TABLE 17
Adsorption test

| Firing duration | Adsorption removal ratio [%] | | | | Properties of filtrate | |
|---|---|---|---|---|---|---|
| [min] | As(III) | F | Pb | Average | pH | ORP[mV] |
| 0 | 24.7 | 28.4 | 99.6 | 50.9 | 10.1 | 216 |
| 10 | 92.4 | 89.7 | 99.6 | 93.9 | 10.8 | 193 |
| 20 | 95.2 | 94.1 | 99.6 | 96.3 | 10.9 | 192 |
| 30 | 96.0 | 96.4 | 99.6 | 97.3 | 10.9 | 187 |
| 40 | 95.7 | 96.4 | 99.6 | 97.2 | 10.9 | 189 |
| 50 | 84.4 | 79.4 | 99.6 | 87.8 | 11.4 | 152 |
| 60 | 77.6 | 57.9 | 99.6 | 78.4 | 11.6 | 132 |
| 120 | 42.3 | 12.9 | 44.1 | 33.1 | 12.6 | 52 |

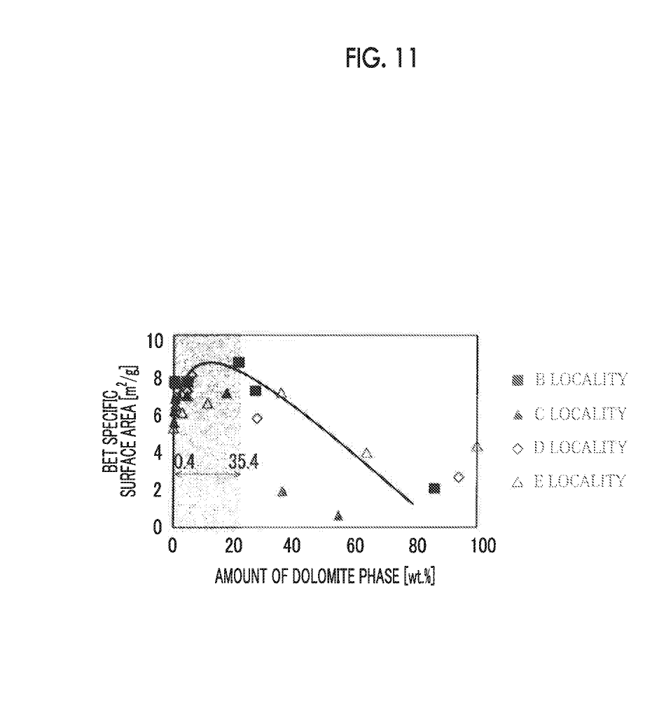

In addition, FIG. 11 illustrates a view of the relationship between the specific surface area of the dolomite-based material and the dolomite phase residual amount attributed to the difference in localities.

From the above tables and drawings, it is found that a high specific surface area is provided by setting the content of the dolomite phase (CaMg(CO₃)₂ phase) remaining in half-fired dolomite to 0.4δ×δ35.4 (wt %). In addition, it is found by measuring the fine pore volume, separately from the specific surface area, that fine pores are formed due to firing, and it is also found that the dolomite-based material becomes porous.

The above-described dolomite-based material having a high specific surface area of the present invention is capable of effectively adsorbing heavy metal, halogen and metalloid.

In addition, 100 ml of respective solutions containing 5 mg/1 and 100 mg/1 of arsenic (As) were prepared using the reagents shown in Table 11. Uniform mixtures obtained by adding 1 g of half-fired dolomite in Table 1 in which the content of the dolomite (CaMg(CO₃)₂) phase remaining in the half-fired dolomite is2.6 wt % to the above solutions respectively by four-hour vibration and uniform mixtures obtained by adding 0.9 g of the half-fired dolomite and 0.1 g of ferrous sulfate to the solutions respectively by four-hour vibration were prepared. After that, the respective solutions were separated into solid and liquid, the amounts of residual arsenic in filtrates were measured by the method shown in Table 12, and respective arsenic adsorption removal ratios (%) were calculated. The results are shown in Table 18.

In addition, the pH and oxidation-reduction potential

(ORP) of the filtrates were measured using a desktop pH meter: F-73 manufactured by Horiba, Ltd. (pH electrode: 9615S-10D, ORP electrode: 9300-10D). The results are also shown in Table 18.

TABLE 18

| | | | Properties of filtrate | |
|---|---|---|---|---|
| | As 5 mg/l | As 100 mg/l | pH | ORP[mV] |
| Half-fired dolomite | 95 | 95.6 | 11.6 | 200 ± 10 |
| Half-fired dolomite + | 99.4 | 97.2 | 10.6 | 250 ± 10 |
| ferrous sulfate | | | | |

From Table 18, it is found that, when ferrous sulfate is added to the half-fired dolomite which is the dolomite-based material having a high specific surface area of the present invention in which the content of the residual dolomite (CaMg(CO₃)₂) phase is 0.4δ×δ35.4 (wt %), the adsorption removal ratio of heavy metal, halogen and metalloid further increases.

The present invention is capable of easily providing a dolomite-based material having a high specific surface area regardless of localities or the composition of raw dolomite material and thus can be applied to efficiently adsorb and remove harmful heavy metal, halogen, and metalloid in waste water or soils, and, for example, can be effectively applied to a treatment of a large amount of contaminated soils containing heavy metal, halogen and metalloid generated due to an excavation work and a construction work for tunnels or dams or a treatment of waste water containing heavy metal, halogen and metalloid from plants and factories.

What is claimed is:

1. A dolomite-based material having a high specific surface area,
wherein the dolomite-based material is half-fired dolomite, and
a content of a residual CaMg(CO₃)₂ phase in the half-fired dolomite, which is analyzed using a Rietveld method by means of powder X-ray diffraction, is 0.4δ×δ35.4 (wt %).

2. The dolomite-based material having a high specific surface area according to claim 1, further comprising:
ferrous sulfate.

3. A method for preparing a dolomite-based material having a high specific surface area comprising;
firing dolomite so that a content of a residual CaMg(CO₃)₂ phase in the obtained dolomite-based material, which is analyzed using a Rietveld method by means of powder X-ray diffraction, is 0.4δ×δ35.4 (wt %).

4. The method for preparing a dolomite-based material having a high specific surface area according to claim 3, further comprising;
blending ferrous sulfate in the obtained dolomite-based material.

5. A method for controlling a quality of a dolomite-based material having a high specific surface area comprising;
adjusting a residual amount of a residual CaMg(CO₃)₂ phase in the obtained dolomite-based material by firing dolomite so that a content of the residual CaMg(CO₃)₂ phase in the obtained dolomite-based material, which is analyzed using a Rietveld method by means of powder X-ray diffraction, is 0.4δ×δ35.4 (wt %).

6. A method for adsorbing heavy metal, halogen and metalloid, comprising;
using the dolomite-based material having a high specific surface area of claim 1.

7. A method for adsorbing heavy metal, halogen and metalloid, comprising;
using the dolomite-based material having a high specific surface area of claim 2.
